(19) United States
(12) Patent Application Publication
(10) Pub. No.: US 2026/0284804 A1
(43) Pub. Date: Sep. 24, 2026

(54) HANDLING DEVICE AND HANDLING METHOD FOR HANDLING A PLATE-SHAPED MATERIAL

(71) Applicant: TRUMPF Werkzeugmaschinen SE + Co. KG, Ditzingen (DE)

(72) Inventors: Stefan Krause, Wilthen (DE); Clemens Kumpe, Cunewalde (DE); Markus Berthold, Schmoelln- Putzkau (DE)

(21) Appl. No.: 19/670,038

(22) Filed: May 7, 2026

Related U.S. Application Data
(63) Continuation of application No. PCT/EP2024/082146, filed on Nov. 13, 2024.

(30) Foreign Application Priority Data
Nov. 13, 2023 (DE) 10 2023 131 417.3

(51) Int. Cl. B23K 37/04; B23K 26/38; B23K 101/18

(52) U.S. Cl. CPC B23K 37/0408; B23K 26/38; B23K 2101/18

(57) ABSTRACT

A handling device handles a plate-shaped material. The handling device include a support frame including at least one longitudinal strut and at least one transverse strut; a gripping device arranged on the support frame, and which has two guide strips which are oriented towards each other, configured to be moved on the support frame and be adjusted in a mutually spaced manner; and a gripper arranged on each guide strip and including a gripping element and a clamping element configured to be converted into an open position and a closed position. The support frame is provided with a support structure which extends on a plane or parallel to a plane of the support frame. The grippers are configured be moved at least partly within the support structure. In a gripping position, the grippers fix the plate-shaped material to rest against the support structure in a transport position.

### CROSS REFERENCE TO RELATED APPLICATIONS

This application is a continuation of International Application No. PCT/EP2024/082146 (WO 2025/104068 A1), filed on Nov. 13, 2024, and claims benefit to German Patent Application No. DE 10 2023 131 417.3, filed on Nov. 13, 2023. The aforementioned applications are hereby incorporated by reference herein.

### FIELD

The present disclosure relates to a handling device and a handling method for handling a plate-shaped material, in particular for feeding it into and removing it from a processing machine.

### BACKGROUND

From WO 2022/118544 A1, a handling device for handling a plate-shaped material, in particular a machined plate-shaped workpiece, is known. The plate-shaped material rests on a workpiece support in a processing machine, which is cut into individual workpieces and a residual grid by means of a cutting process. A handling device is provided for removing the residual grid from the workpiece support. This handling device comprises a support frame with two longitudinal struts and two transverse struts. Guide strips are provided on the transverse struts, aligned parallel to the longitudinal struts of the support frame. The two outer guide strips can be moved towards each other along the transverse struts. A plurality of grippers are provided on these movable guide strips, which can be moved along the guide strip. These grippers, arranged along the movable guide strips, are designed to grip one longitudinal side of the residual grid. Between the movable guide strips, further guide strips are provided, which are fixed to the transverse struts. Grippers are provided to be movable along the fixed guide strips. These grippers can be adjusted to the length of the residual grid and grip the narrow sides of the residual grid. Such a support frame allows the grippers to be adapted to the format of the plate-shaped material or residual grid to be handled, so that the grippers can grip all four side edges of the residual grid for handling.

Although this handling device can be flexibly adjusted to the format of the plate-shaped material or residual grid to be handled, it has the disadvantage that sagging or bending can occur when handling a plate-shaped workpiece or residual grid. This means that high movement speeds are not possible during handling. Furthermore, when removing the residual grid with workpieces still arranged in it, bending may cause jamming or catching between the workpieces in the residual grid.

### SUMMARY

In an embodiment, the present disclosure provides a handling device for handling a plate-shaped material, including a support frame which includes at least one longitudinal strut and at least one transverse strut; a gripping device which is arranged on the support frame, and which has two guide strips which are oriented towards each other, configured to be moved on the support frame and be adjusted in a mutually spaced manner; and at least one gripper which is arranged on each guide strip and includes a gripping element and a clamping element configured to be converted into an open position and a closed position. The support frame is provided with a support structure which extends at least partly on a plane or parallel to a plane of the support frame. The grippers are configured be moved at least partly within the support structure. In a gripping position, the grippers fix the plate-shaped material so as to rest against the support structure in a transport position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a machine arrangement with a processing machine and a handling apparatus;

FIG. 2 shows a schematic view of a handling device of the handling apparatus according to FIG. 1;

FIG. 3 shows a schematic sectional view along line III-III in FIG. 2;

FIG. 4 shows a perspective view of the handling device with a plate-shaped material fixed thereto;

FIG. 5 shows a schematic side view of the handling device in a first step of a handling method;

FIG. 6 shows a schematic side view of the handling device in a second step of the handling method; and

FIG. 7 shows a schematic side view of an alternative embodiment of a gripper compared to FIG. 5.

### DETAILED DESCRIPTION

Aspects of the present disclosure provide a handling device and a handling method for handling a plate-shaped material, thereby enabling safe handling with a high dynamic traversing movement.

An aspect of the present disclosure provides a handling device for handling a plate-shaped material, which comprises a support frame consisting of at least one longitudinal strut, preferably two longitudinal struts, and at least one transverse strut, preferably two transverse struts, wherein a gripping device is arranged on the support frame, which has two mutually aligned guide strips which can be moved on the support frame and can be adjusted in a mutually spaced manner. At least one gripper is arranged in or on each guide strip, the grippers comprising a gripping element and a clamping element which can be converted into an open position and a gripping position. A support structure is provided on the support frame, which extends at least partly in a plane or parallel to the plane of the support frame, wherein the grippers are at least partially movable within the support structure and fix the plate-shaped material adjacent to the support structure in a transport position. This allows the lower face of the plate-shaped material to be supported without load, except for a few clamping points. Furthermore, the lower face of the plate-shaped material is not mechanically covered or only slightly covered.

This handling device has the advantage that the plate-shaped material to be handled is fixed adjacent to or clamped to the support structure. This prevents or minimizes bending of the plate-shaped material. This allows high dynamic feed movements to be reliably performed. Furthermore, plate-shaped materials can be handled regardless of their material thickness. The handling device enables the handling of the plate-shaped material both as raw material, i.e., unprocessed plate-shaped material, in particular sheet metal, as a partly processed plate-shaped material, or as a processed plate-shaped material which has been wholly or partly separated into a residual grid and at least one workpiece by means of a cutting process in a processing machine.

In an aspect, to convert the plate-shaped material into a transport position in which the plate-shaped material is fixed adjacent to the support structure or clamped thereto, the grippers can be moved relative to the support structure, or the support structure relative to the grippers, or the grippers and the support structure relative to each other. This feed movement can preferably be adjusted depending on the thickness of the plate-shaped material to be handled. This ensures that the plate-shaped material being handled is held at least slightly under tension adjacent to the support structure.

In a preferred aspect, the movable guide strips are aligned parallel to the at least one longitudinal strut or to the longitudinal struts of the support frame. This allows the gripping device to be adjusted to the width of the plate-shaped material and the grippers to grip the opposing longitudinal sides of the plate-shaped material. The plate-shaped material typically has a rectangular shape. The gripping device can thus grip the longitudinal sides of the plate-shaped material in order to fix it adjacent to the support structure. Preferably, the gripping device is designed to grip only the longitudinal sides of the plate-shaped material. In this aspect, it is not necessary to additionally align the grippers to engage a narrow side of the plate-shaped material.

Furthermore, in a preferred aspect, the guides are movable along the at least one or the transverse struts of the support frame and can be adjusted in distance to the format of the plate-shaped material to be handled by at least one actuator. These actuators can be electric, hydraulic, pneumatic, and/or magnetic drives. The traversing movement of the actuators is controlled and/or monitored by a control system. The actuators are advantageously integrated on or in the transverse struts of the support frame. However, these can also be external (e.g., chain or belt drives) and exert the movement on the guides by means of a transmitter.

In an aspect, the support structure arranged on the support frame is designed as a planar, extending support structure, at least on its lower face. A contact surface for the plate-shaped material to assume the transport position is preferably provided on a lower face of the support structure.

The contact surface of the support structure for the plate-shaped material can be formed, for example, by a multitude of bristles, by a plurality of brush strips arranged next to each other, by an elastically compliant layer on a carrier plate, or by groove-shaped projections.

In a preferred aspect, the support structure includes openings, in particular longitudinal openings, within which the grippers with the guide strips can be moved. These longitudinal openings are preferably designed parallel to the narrow side of the support structure and allow a traversing movement in the direction of a longitudinal central axis of the plate-shaped material to be handled. This allows the grippers to be adjusted to different sizes of the format of the plate-shaped material being handled. Secondly, the support structure can substantially extend over the largest format of the plate-shaped material to be handled and form a contact surface for assuming the transport position.

According to a preferred aspect of the gripper, the clamping element of the gripper is provided to rest on the support structure and the gripping element of the gripper extends below the support structure. After gripping the plate-shaped material from behind or underneath, the gripper can be converted into the transport position, whereby the gripping element fixes the plate-shaped material against the lower face of the support structure and clamps it against the clamping element of the gripper.

In the aspect described above, it is preferably provided that the clamping element of the gripper is designed as a plate which is positioned in the longitudinal opening and/or covers the width of the longitudinal opening. This has the advantage that the support structure is virtually closed in the area of the longitudinal opening in which the gripper is positioned to be movable.

According to an alternative design of at least one gripper, it can be provided that the clamping element and the gripping element are positioned in an open position of the gripper below the support structure and can be converted in a first step into a closed position to fix the plate-shaped material between the clamping element and the gripping element, and subsequently, in a second step, the gripper can be converted from the closed position into the transport position, in which the plate-shaped material is fixed against the support structure. This aspect allows, firstly, the edge of the plate-shaped material to be securely fixed and, secondly, a clamping frame to be formed by the grippers. Additionally, this tensioned, plate-shaped material is fixed adjacent to the support structure.

In a preferred aspect of the aspect described above, a clamping plate may be provided on the support structure, covering and/or extending into the longitudinal opening. This allows the fixation of the plate-shaped material to the support structure to be further increased.

The gripping elements of the gripper can be designed, for example, as a gripping hook or as a gripping mandrel. Depending on the type and/or thickness of the material to be handled, an appropriate selection can be made.

Advantageously, in an aspect, at least one sensor is provided on the grippers and/or on the guide strips, by which a position of the gripper relative to an edge of the plate-shaped material to be handled can be detected. This at least one sensor allows the traversing movement of the guide strips to be controlled, so that the grippers provided in an open position are aligned with the edge of the plate-shaped material. Subsequently, the grippers can be moved into a closed position by the control system.

An aspect of the present disclosure provides a handling method for handling a plate-shaped material, in which a handling device according to one of the aspects described above is provided. The handling method provides that the handling device is positioned in an initial position relative to the plate-shaped material to be handled, in which a gripping area of the grippers is aligned with the edge of the plate-shaped material. The support structure can be positioned resting on the plate-shaped material. In this initial position, the guide strips have a distance between them which is greater than a format, in particular a longitudinal side, of the plate-shaped material to be handled. Subsequently, the guide strips are moved along the support frame and towards the respective edge of the plate-shaped material until the plate-shaped material is positioned in the gripping area of the grippers. The grippers are then moved into a closed position and the plate-shaped material is fixed adjacent to the support structure in the transport position. This handling method enables mechanical clamping of the plate-shaped material. Furthermore, the close fixation of the plate-shaped material to the support structure enables the handling of the gripping device with high dynamic traversing movements or feed movements. Furthermore, such a handling method has the advantage that, by gripping the plate-shaped material at the surrounding edge, an additional receiving opening in the plate-shaped material or workpiece is not required, into which gripping elements for handling the plate-shaped material are positioned.

Further advantageous embodiments and developments thereof are described and explained in more detail below by means of the examples illustrated in the drawings. The features that can be derived from the description and the drawings can be used individually or in any combination together according to the present disclosure.

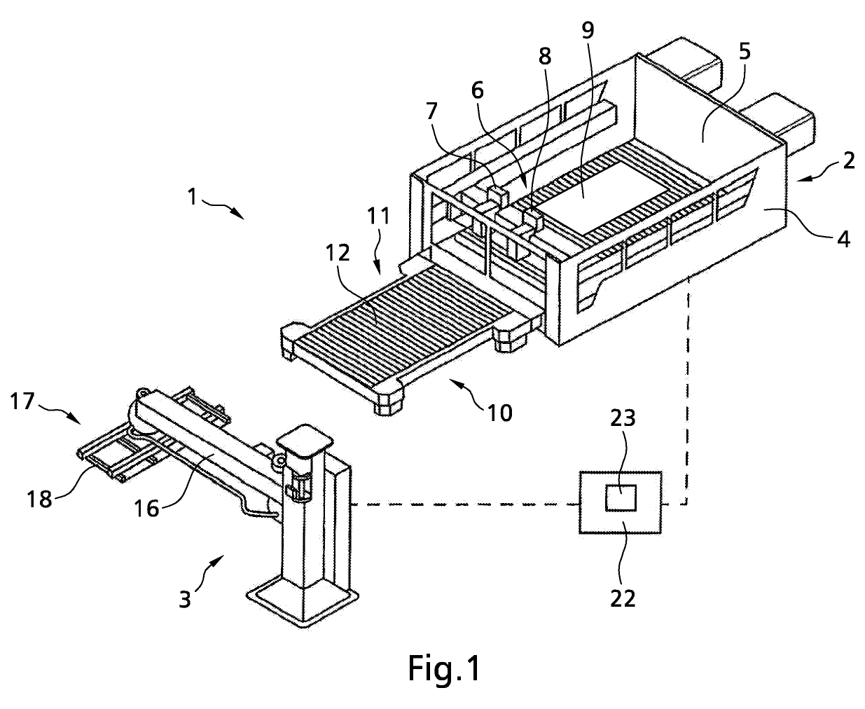

FIG. 1 shows a perspective view of a machine arrangement 1. This machine arrangement comprises a processing machine 2, which is designed, for example, as a laser cutting machine. Furthermore, the machine arrangement 1 comprises a handling apparatus 3. The processing machine 2 comprises a working area 5 limited by an enclosure 4, in which a cutting unit 6 with laser cutting heads 7, 8 can be moved in a horizontal plane of motion as a production unit. This cutting unit 6 is only an example. A pallet changer 10 is provided, which is assigned to the working area 5 of the processing machine 2. The pallet changer 10 comprises a pallet 11 with a workpiece support 12. This pallet 11 can be moved into and out of the working area 5. For processing a plate-shaped material 9, it is positioned on the workpiece support 12 of the pallet 11. Together with the pallet 11, the unprocessed plate-shaped material 9 is moved from the pallet changer 10 into the working area 5 of the processing machine 2. In the working area 5, the cutting processing of the plate-shaped material 9 then takes place using the cutting unit 6. This process produces one or a plurality of workpieces. It may also be provided that at least one workpiece and one residual grid are produced from the plate-shaped material 9. The term “plate-shaped material” 9 encompasses both unprocessed plate-shaped material, in particular a raw sheet, as well as partially processed plate-shaped material, a workpiece, and a residual grid. After the cutting process has been completed, the pallet 11 with the processed plate-shaped material 9 is moved back onto the pallet changer 10.

The machine arrangement 1 is controlled and monitored by a control unit 22. On this control unit 22, one or a plurality of processing programs 23 run, which issue control commands to control both the processing machine 2 and the handling apparatus 3 according to the predetermined work sequences.

The handling apparatus 3 comprises, for example, a horizontally pivotable swivel arm 16, on which a handling device 17 is provided for handling the plate-shaped material 9. Instead of the swivel arm 16, a multi-section arm or a linear axis unit can also be provided, which can be controlled in a plurality of spatial axes. The handling apparatus 3, together with the handling unit 17, enables the loading and unloading of the pallet 11. The handling apparatus 3 can take unprocessed, plate-shaped material 9 from a storage station and guide it to the pallet 11. Furthermore, the handling apparatus 3 can remove the processed plate-shaped material 9 from the pallet 11 and transfer it to an unloading station. The handling tasks are not limited thereto.

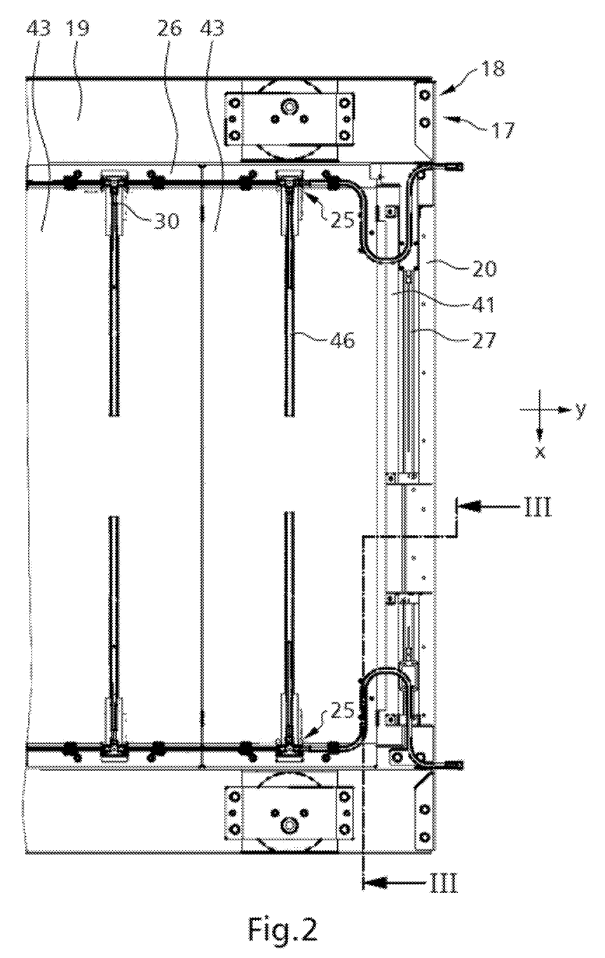

The handling device 17 comprises a support frame 18. This support frame 18 is substantially rectangular in shape. This support frame 18 is articulated on the swivel arm 16 of the handling apparatus 3 and is preferably provided in a replaceable manner. The structure of the handling device 17 is described in more detail below in FIGS. 2 to 4.

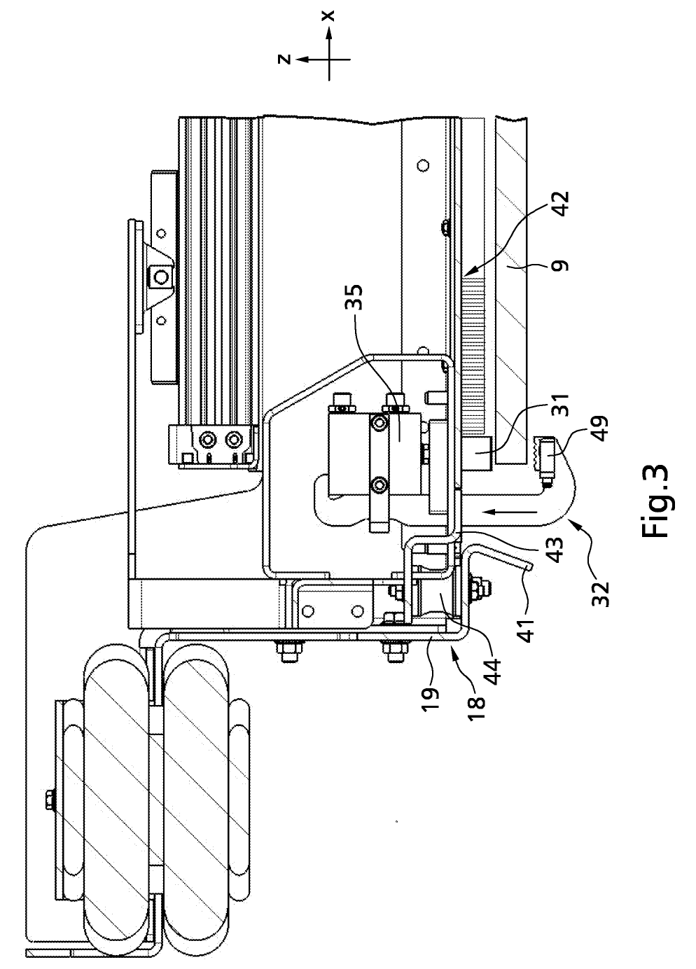

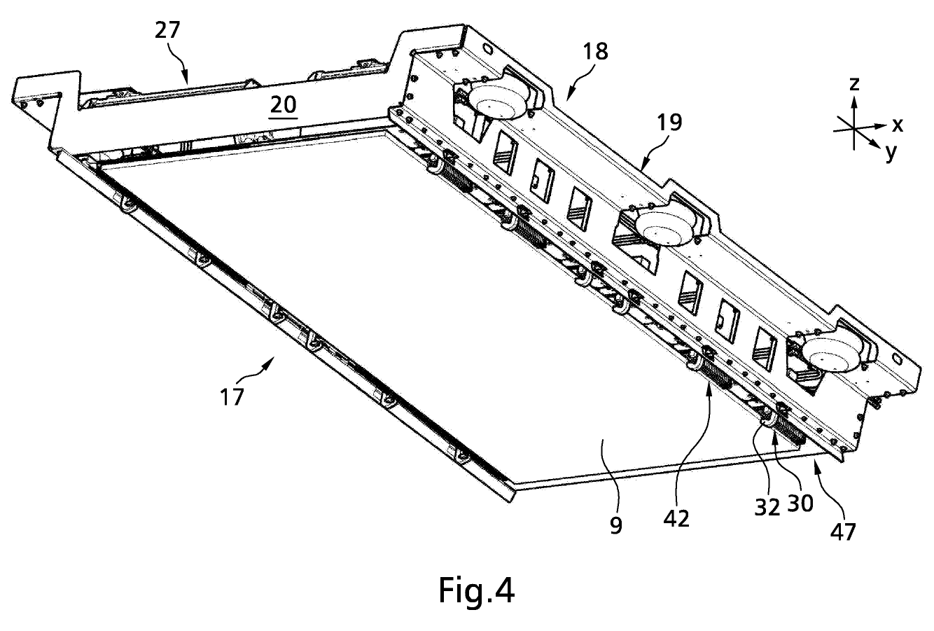

FIG. 2 shows a schematic view from above of the handling device 17. FIG. 3 shows a schematic sectional view along the line III-III in FIG. 2. FIG. 4 shows a perspective view from below of the handling device 17 with a plate-shaped material 9 held for handling. The handling device 17 comprises the support frame 18, which comprises two longitudinal struts 19 and two transverse struts 20, which in particular form a closed, circumferential frame. For the sake of clarity, the support frame 18 can be connected to the handling apparatus 3, in particular the swivel arm 16, through a coupling point.

A gripping device 25 is provided on the support frame 18. This gripping device 25 comprises two opposing guide strips 26, which preferably extend parallel to the longitudinal struts 19 of the support frame 18. These guide strips 26 are mounted on the support frame 18 with their spacing being variable. Preferably, at least one actuator 27 is provided, by means of which the guide strips 26 are controlled to be movable, in particular in and against a direction to the longitudinal central axis of the support frame 18. Advantageously, guides are provided on the transverse struts 20 of the support frame 18, along which the guide strips 26 are guided in a movable manner.

The gripping device 25 further comprises at least one gripper 30 arranged on each guide strip 26. Preferably, a plurality of grippers 30 are provided on each guide strip 26. The grippers 30 are preferably provided at a distance, fixed or stationary relative to one another on the guide strip 26. The distance between the grippers 30 cannot be adjusted to the length of the longitudinal side of the plate-shaped material 9. The gripper 30 comprises a clamping element 31 and a gripping element 32. These can be moved relative to each other to be converted from an open position 33 into a closed position 34. Alternatively, it can also be provided that the clamping element 31 is fixed and the gripping element 32 can be moved, in particular controlled by a lifting drive 35. Each of these grippers 30 can be individually or jointly controlled by the control unit 22 for opening and closing.

The support frame 18 extends along a plane formed by an X-axis and a Y-axis. The guide strips 26 arranged on the support frame 18 accommodate at least the gripping element 32 of the gripper 30 so as to be movable along a Z-axis. Preferably, a lifting drive 35 is provided on each gripper 30. Thus, each gripper 30 can be controlled for opening and closing. Preferably, the gripper 30 can also be moved in a position along the Z-axis relative to the X-Y plane of the support frame 18.

Within the support frame 18, a support structure 41 extends at least partly. This support structure 41 preferably comprises a planar extension. A contact surface 42 is preferably formed on a lower face of the support structure 41. The lower face of the support structure 41 is the side which, when positioning the handling device 17 towards the plate-shaped material 9, points in the direction of the plate-shaped material 9. The support structure 41 can preferably consist of a plurality of segments 43. These segments 43 are preferably fixed to the longitudinal struts 19 of the support frame 18, in particular in a replaceable manner. Advantageously, the support structure 41, in particular the segments 43, can be fixed to the support frame 18 by means of a bearing 44. This bearing 44 can be a vibration-damping or vibration-absorbing bearing 44. It can also be designed to be at least slightly flexible along the Z-axis. In the embodiment shown in FIG. 3, the support structure 41 is arranged in a fixed orientation by the bearing 44 in its position and location relative to the support frame 18. Alternatively, it can be provided that the support structure 41 can be moved up and down relative to the support frame 18, i.e., can be moved along the Z-axis. The support structure 41 preferably extends over its entire surface within the support frame 18 or in a plane parallel to the support frame 18. This allows the contact surface 42 to also extend completely fully over the format of the plate-shaped material 9 to be handled. The format of the support structure 41 is preferably designed to match the size of the format of the plate-shaped material 9 to be handled.

The contact surface 42 of the support structure 41 can be designed as a planar, continuous surface. Alternatively, it can be provided that the contact surface 42 is formed by a multitude of bristles or a plurality of brush strips aligned parallel to each other. Further materials or elements may also be used that allow unobstructed contact with the support structure 41 even if burn-off, contamination, or melting occurs on the side of the plate-shaped material 9 facing the contact surface 42 of the support structure 41.

Within the support structure 41, in particular within a segment 43, at least one longitudinal opening 46 is provided. This longitudinal opening 46 is aligned perpendicular to a longitudinal central axis of the support frame 18. The gripper 30 extends within the longitudinal opening 46. Due to the movable arrangement of the guide strips 26, the grippers 30 can be moved in the X-direction within the longitudinal opening 46 of the support structure 41, allowing the grippers 30 to be adjusted to the size of the plate-shaped material 9 to be handled. At least the gripping element 32 of the gripper 30 is positioned below a contact surface 42 of the support structure 41.

FIG. 4 shows a schematic view from below of the handling device 17. The handling device 17 picks up the plate-shaped material 9 by means of the grippers 30. In this arrangement, a traversing or transport movement is carried out by the handling apparatus 3 in order to feed the plate-shaped material 9 to the pallet changer 10, or to remove it from the pallet changer 10. A transport movement can also be carried out between the loading station and the unloading station and a further station. During such transport of the plate-shaped material 9 by the handling device 17, the plate-shaped material 9 is fixed in a transport position 47 adjacent to the contact surface 42 of the support structure 41. This can minimize or prevent the bending of the plate-shaped material 9 during transport. This enables a high dynamic transport movement, resulting in short cycle times within the machining process.

The handling device 17 can remove the plate-shaped material 9 directly from the pallet 11. Alternatively, after an intermediate step, the handling device 17 may remove the plate-shaped material not directly from the pallet 11 but from another handling unit to which the plate-shaped material 9 has been temporarily transferred and stored.

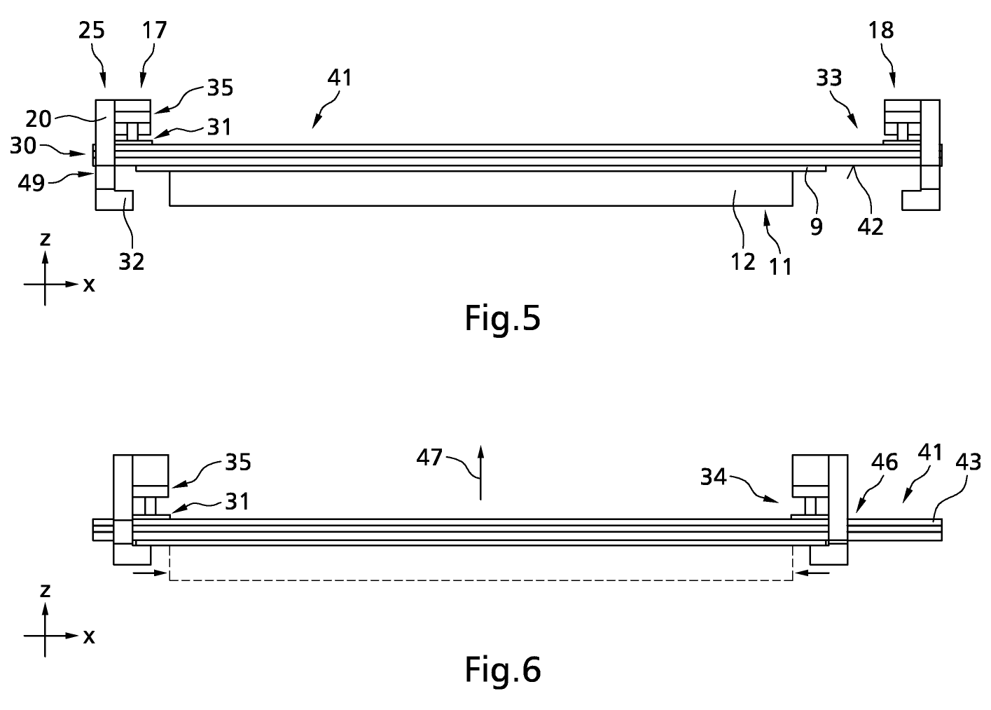

FIGS. 5 and 6 schematically illustrate, in simplified form, two steps for positioning the handling device 17 relative to the plate-shaped material 9 to be gripped. The plate-shaped material 9 can be positioned on the workpiece support 12 of the pallet 11 as shown in FIG. 5. Alternatively, the plate-shaped material 9 can also be positioned on a shelf in the unloading station or storage station. The handling device 17 is positioned above the plate-shaped material 9 by the handling apparatus 3. The guide strips 26 are converted into an open position which is larger than the format of the plate-shaped material 9 to be handled. Thus, the guide strips 26 are moved along the X-axis so that the grippers 30 have a distance between them which is greater than the width of the plate-shaped material 9. The grippers 30 are converted into an open position 33. Subsequently, the handling device 17 is lowered until it rests on the plate-shaped material 9 with the contact surface 42 of the support structure 41. This position can be detected by sensors which are provided and/or integrated on or in the support structure 41. Subsequently, a traversing movement of the guide strips 26 is controlled by the actuator 27, so that the grippers 30 are fed in the direction towards the longitudinal side of the plate-shaped material 9. Advantageously, a further sensor 49 is provided on each gripper 30, by which the travel position of the gripper 30 is detected. As soon as an edge area of the plate-shaped material 9 is positioned within a gripping area of the gripper 30, the feed movement, i.e., the traversing movement of the guide strips 26 towards each other, is stopped. Subsequently, the grippers 30 are converted from the open position 33 into the closed position 34. In this process, the edge regions of the plate-shaped material 9 are fixed in place, in particular by jamming or clamping. This results in the plate-shaped material 9 being fixed adjacent to the contact surface 42 of the support structure 41 in the transport position 47. The grippers 30, which engage the longitudinal sides of the plate-shaped material 9, form a kind of clamping frame for the fixed positioning of the plate-shaped material 9 on the support structure 41.

Preferably, it is provided that when the grippers 30 are converted from the open position 33 into the closed position 34, the clamping element 31 remains positioned resting on the support structure 41. This allows for easy control and quick fixing of the plate-shaped material 9 to the lower face of the support structure 41.

Alternatively, it can be provided that both the clamping element 31 and the gripping element 32 of the gripper 30 extend within the longitudinal opening 46, so that they are positioned below the contact surface 42 of the support structure 41. In this embodiment, it can be provided that the handling device 17 aligns the gripping device 25, in particular the grippers 30, towards the edge area of the plate-shaped material 9, but the support structure 41 does not rest on the plate-shaped material 9. Subsequently, the edge area of the plate-shaped material 9 is first held in place by the grippers 30 after being converted into the closed position 34. In a subsequent step, the grippers 30 are moved upwards along the Z-axis, whereby the plate-shaped material 9 comes to rest against the contact surface 42 of the support structure 41 and is converted into the transport position 47.

After the handling device 17 has picked up the plate-shaped material 9, the plate-shaped material 9 is moved to the subsequent destination. Subsequently, the plate-shaped material 9 will be positioned on the workpiece support 12 or on a further support, or positioned above a scrap receptacle. Subsequently, the grippers 30 are converted into the open position 33 and the guide strips 26 are converted into an initial position, so that the edge area of the plate-shaped material 9 is free in relation to the gripping area of the grippers 30. Optionally, scrapers are used to remove the plate-shaped material 9 from the grippers 30, causing it to fall downwards. The handling device 17 is then lifted off and is ready for a subsequent handling task.

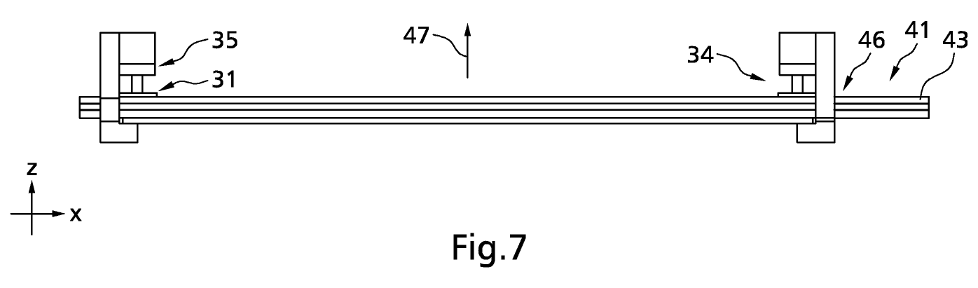

FIG. 7 illustrates a schematic side view of an alternative embodiment of the gripper 30. In this embodiment, the gripping element 32 is designed in the form of a mandrel which, by clamping with the clamping element 31, fixes the plate-shaped material 9.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A handling device for handling a plate-shaped material, comprising:
a support frame which comprises at least one longitudinal strut and at least one transverse strut;
a gripping device which is arranged on the support frame, and which has two guide strips which are oriented towards each other, configured to be moved on the support frame and be adjusted in a mutually spaced manner; and
at least one gripper which is arranged on each guide strip and comprises a gripping element and a clamping element configured to be converted into an open position and a closed position,
wherein the support frame is provided with a support structure which extends at least partly on a plane or parallel to a plane of the support frame,
wherein, the grippers are configured be moved at least partly within the support structure, and
wherein, in a gripping position, the grippers fix the plate-shaped material so as to rest against the support structure in a transport position.

2. The handling device according to claim 1, wherein the grippers are configured to be moved relative to the support structure, the support structure is configured to be moved relative to the grippers, or the grippers and the support structure is configured to be moved relative to one another and the plate-shaped material is positioned adjacent to the support structure.

3. The handling device according to claim 1, wherein the guide strips are aligned parallel to the at least one longitudinal strut of the support frame.

4. The handling device according to claim 1, wherein the guide strips are guided movably along the at least one transverse strut and are configured to be adjusted in distance to a format of the plate-shaped material to be gripped by at least one actuator.

5. The handling device according to claim 1, wherein the support structure extends over a planar area and has a contact surface on a lower face for the plate-shaped material to assume the transport position.

6. The handling device according to claim 5, wherein the contact surface is formed by a multitude of bristles, by a plurality of brush strips, by an elastically compliant layer on a carrier plate, or by groove-shaped projections.

7. The handling device according to claim 1, wherein longitudinal openings are provided in the support structure, within which the grippers are arranged so as to be movable by the guide strips.

8. The handling device according to claim 1, wherein the clamping element of the at least one gripper is configured to rest on the support structure, wherein the gripping element is positioned below the support structure and a contact surface, and wherein the gripping element is configured to be converted into the transport position after gripping behind or around the plate-shaped material and fixing the plate-shaped material against the contact surface of the support structure.

9. The handling device according to claim 8, wherein the clamping element is configured as a pressure plate which engages in a longitudinal opening and/or covers a width of the longitudinal opening on the support structure.

10. The handling device according to claim 1, wherein the clamping element and the gripping element are configured to be positioned in the open position below the support structure, and are configured to be converted into the closed position to fix the plate-shaped material between the clamping element and the gripping element, and subsequently the at least one gripper in the closed position is configured to be converted into the transport position, in which the plate-shaped material is positioned adjacent to the support structure.

11. The handling device according to claim 10, wherein an additional clamping plate is provided on the support structure engaging into a longitudinal opening and/or covering a longitudinal opening.

12. The handling device according to claim 1, wherein at least one sensor is provided on the at least one gripper and/or on the guide strip, by which a position of the at least one gripper relative to an edge of the plate-shaped material can be detected.

13. A handling method for handling a plate-shaped material with a handling device comprising a support frame with at least one longitudinal strut and at least one transverse strut, on which a gripping device is provided, which has two guide strips aligned at a distance to one another, configured to be moved in a mutually spaced manner on the support frame and having at least one gripper which is arranged on a guide strip and comprises a clamping element and a gripping element, configured to be converted into an open position and a closed position, and having a support structure provided on the support frame which support structure extends at least partly on a plane or parallel to a plane of the support frame, comprising:
positioning the handling device above the plate-shaped material to be handled in an initial position in which the guide strips are spaced apart from each other by a distance greater than a format of the plate-shaped material;
moving the support frame towards the plate-shaped material until the plate-shaped material is aligned to a gripping area of the grippers, or the support structure rests on the plate-shaped material;
moving the grippers towards a respective edge of the plate-shaped material by a traversing movement of the guide strips, and
converting the grippers into a gripping position and fixing the plate-shaped material in a transport position adjacent to the support structure.

14. The handling method according to claim 13, wherein, in order to assume the transport position, the grippers are controlled to be movable relative to the support structure, or the support structure relative to the grippers, or the grippers and the support structure relative to each other.
